(19) United States
(12) Patent Application Publication
(10) Pub. No.: US 2005/0001806 A1
(43) Pub. Date: Jan. 6, 2005

(54) Display device and driving method therefore

(76) Inventor: Kohichi Ohmura, Kanagawa (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/864,398

(22) Filed: Jun. 10, 2004

(30) Foreign Application Priority Data
Jun. 24, 2003 (JP) P2003-180069

(51) Int. Cl. G09G 5/00

(52) U.S. Cl. 345/92; 345/204

(57) ABSTRACT

A display device according to the present invention includes: a horizontal driving circuit for sampling a video signal to signal lines Y in each horizontal period (1H); and a vertical driving circuit for sequentially scanning scanning lines X to select each row of pixels. A video signal is written to each selected row of pixels, and video signals for one field are retained. The horizontal driving circuit samples the video signal inverted in polarity in each H to the signal lines Y in each H, whereby an effect of capacitive coupling noise jumping from signal lines Y into pixels is cancelled. The vertical driving circuit sequentially scans the scanning lines X in every other H to select each row of pixels, and writes video signals of an identical polarity in the video signal inverted in polarity in each H to each selected row of pixels (1H thinned-out scanning) and retains the video signals of the identical polarity over one field.

### BACKGROUND OF THE INVENTION

The present invention relates to an active matrix type display device typified by an LCD and a driving method therefor, and particularly to a technique for improving a field inversion driving system.

An active matrix type display device includes: scanning lines arranged in a form of rows; signal lines arranged in a form of columns; pixels arranged in a form of a matrix in correspondence with intersections of the scanning lines and the signal lines; a horizontal driving circuit for sampling a video signal to the signal lines in the form of columns in each horizontal period (H); and a vertical driving circuit for sequentially scanning the scanning lines in the form of rows to select each row (each line) of pixels. The active matrix type display device writes a video signal for each horizontal period to each selected row of pixels, and retains a video signal for one field (1F).

[Patent Literature 1]

Japanese Patent Laid-Open No. 2001-356740

The active matrix type display device generally employs AC inversion driving, which inverts polarity of a video signal to be written to pixels in a predetermined cycle. Driving that inverts the polarity in each field is referred to as 1F inversion, and driving that inverts the polarity of the video signal in each-horizontal period is referred to as 1H inversion. The 1F inversion conventionally has problems to be solved such as flicker in each field, a characteristic crosstalk referred to as a vertical crosstalk, and the like. On the other hand, the 1H inversion does not cause noticeable flicker or crosstalk, and is thus currently mainstream.

As compared with the 1F inversion, however, the 1H inversion is not satisfactory in terms of contrast and life because the 1H inversion changes the polarity of the video signal at high speed.

The 1F inversion is drawing renewed attention from a viewpoint of improving the contrast and lengthening the life. Obstacles to employment of the 1F inversion are the problems of flicker and vertical crosstalk mentioned above. The present specification focuses on vertical crosstalk in particular. A vertical crosstalk appears when a black window is displayed against a gray background on a normally white mode LCD, for example. The vertical crosstalk is called so because contrast of background parts positioned over and under the black window is different from contrast of the other background parts.

A pixel of an LCD panel in principle has a parasitic capacitance between the pixel and signal lines, so that variation in potential of the signal lines varies pixel potential (coupling noise from the signal lines). Supposing for example that a voltage of a video signal for displaying the gray background parts is 7.5±2.0 V and that a voltage of a video signal for the black window part is 7.5±5.0 V, the potential variation is Δ3.0 V when writing reaches the window part after being started in the background part. This variation in potential of the signal lines varies the potential of the pixel due to coupling effects on the pixel. This is the cause of vertical crosstalk. In the 1H inversion, the polarity of the video signals is changed in each horizontal period, and therefore coupling is cancelled. In the 1F inversion, however, video signals of the same polarity are inputted during a field period, and therefore coupling is not cancelled. As a result, the gray background part situated over the black window becomes higher in potential than the other background parts, and thus becomes correspondingly darker than the other background parts. On the other hand, the background part situated under the black window becomes lower in potential than the other background parts, and thus becomes lighter than the other background parts. This is visually perceived as a vertical crosstalk appearing over and under the black window. The greater the coupling effects, the more noticeable the vertical crosstalk.

### SUMMARY OF THE INVENTION

In view of the problems of the prior art described above, it is an object of the present invention to provide a display device and a driving method therefor that can suppress vertical crosstalk, which is noticeable in the 1F inversion. The following means are taken to achieve the above object. There is provided a display device comprising: scanning lines arranged in a form of rows; signal lines arranged in a form of columns; pixels arranged in a form of a matrix in correspondence with intersections of the scanning lines and the signal lines; a horizontal driving circuit for sampling a video signal to the signal lines in the form of columns in each horizontal period; and a vertical driving circuit for sequentially scanning the scanning lines in the form of rows to select each row of pixels. A video signal for each horizontal period is written to each selected row of pixels and video signals for one field are retained, and polarity of video signals retained in each field is inverted. The horizontal driving circuit samples the video signal inverted in polarity in each horizontal period to the signal lines in the form of columns in each horizontal period, whereby an effect of coupling noise between the signal lines and the pixels is cancelled. The vertical driving circuit sequentially scans the scanning lines in the form of rows in every other horizontal period to select each row of pixels, and writes video signals of an identical polarity in the video signal inverted in polarity in each horizontal period to each selected row of pixels (1H thinned-out scanning) and retains the video signals of the identical polarity over one field.

The horizontal driving circuit samples the video signal inverted in polarity in each horizontal period to the signal lines in the form of columns in each horizontal period. This is therefore the same as in normal 1H inversion driving up to the signal lines. Since the polarity of the video signal is inverted in each horizontal period, the effect of capacitive coupling noise jumping from a signal line into a pixel is cancelled. As a result, vertical crosstalk is not noticeable. On the other hand, the vertical driving circuit sequentially scans the scanning lines in the form of rows in every other horizontal period to select each row of pixels, and writes video signals of an identical polarity in the video signal inverted in polarity in each horizontal period to each selected row of pixels. In the present specification, this driving system, in which horizontal periods are thinned out once in every two horizontal periods, will be referred to as thinned-out 1H inversion driving. This thinned-out 1H inversion enables video signals of an identical polarity to be written and retained in pixels over one field. Video signals of an opposite polarity can be similarly written and retained in a next field by the thinned-out 1H inversion. Thus, 1F inversion driving is performed for the pixels. According to the present invention, 1H inversion is performed up to the signal lines, and 1F inversion is performed for the pixels. Thinned-out 1H inversion driving is employed to make 1H inversion for the signal lines and 1F inversion for the pixels compatible with each other. It is thereby possible to effectively suppress vertical crosstalk specific to 1F inversion.

### BRIEF DESCRIPTION OF THE DRAWINGS

FIG. 1 is a schematic diagram showing a part for one pixel of an active matrix type display device;

FIG. 2 is a schematic diagram showing a vertical crosstalk appearing on a screen in conventional 1F inversion driving;

FIG. 3 is a timing chart of conventional 1F inversion driving and 1H inversion driving;

FIG. 4 is a block diagram showing an embodiment of a display device according to the present invention;

FIG. 5 is a timing chart of assistance in explaining operation of the display device shown in FIG. 4;

FIG. 6 is a schematic diagram showing an example of a screen appearing on the display device shown in FIG. 4;

FIG. 7 is a timing chart of assistance in explaining operation of the display device shown in FIG. 6;

FIG. 8 is a timing chart for a comparison between normal 1H inversion driving and thinned-out 1H inversion driving according to the present invention;

FIG. 9 is a timing chart of a blanking period;

FIG. 10 is a timing chart of a succeeding blanking period; and

FIG. 11 is a timing chart of a preceding blanking period.

### DETAILED DESCRIPTION OF THE PREFERRED EMBODIMENTS

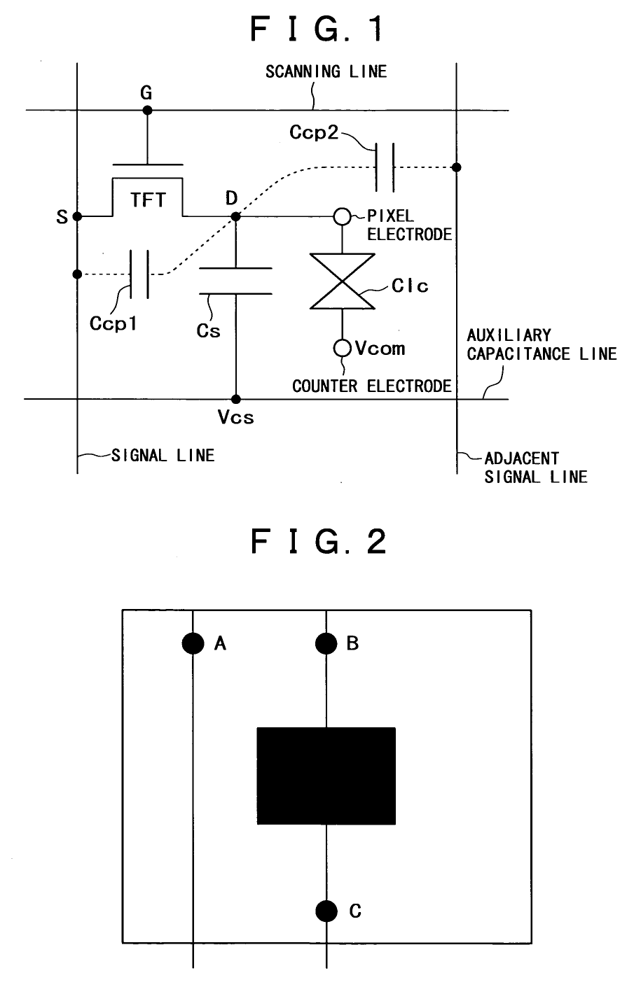

A preferred embodiment of the present invention will hereinafter be described in detail with reference to the drawings. In order to clarify the background of the present invention, description will first be made of a vertical crosstalk with reference to FIGS. 1 to 3.

FIG. 1 is a schematic circuit diagram showing a part for one pixel of an active matrix type display device. As shown in FIG. 1, the pixel is formed at an intersection of a signal line and a scanning line. In the example shown in FIG. 1, the pixel comprises a liquid crystal cell Clc and a thin-film transistor TFT for driving the liquid crystal cell Clc. The TFT has a gate electrode G connected to the scanning line, a source electrode S connected to the signal line, and a drain electrode D connected to the liquid crystal cell Clc. The liquid crystal cell Clc is formed by a liquid crystal retained between a pixel electrode and a counter electrode. The pixel electrode is connected to the drain electrode D of the TFT, while a common voltage Vcom is commonly applied to the counter electrode of each pixel. An auxiliary capacitance Cs is connected in parallel with the liquid crystal cell Clc. The auxiliary capacitance Cs has one electrode connected to the drain electrode D of the TFT, while a predetermined voltage Vcs is applied to another electrode of the TFT via an auxiliary capacitance line.

The signal line is supplied with a video signal from a horizontal driving circuit (not shown). A selecting pulse is applied to the scanning line from a vertical driving circuit (not shown). The TFT conducts in response to the selecting pulse so that the video signal is written from a signal line side to a pixel electrode side. When the selecting pulse is cleared, the TFT is brought into a non-conducting state to disconnect the signal line and the pixel electrode from each other. In practice, however, there is a parasitic capacitance Ccp1 between the signal line and the pixel electrode, producing coupling effects on the pixel. Similarly, there is a parasitic capacitance Ccp2 between the pixel electrode and an adjacent signal line, producing coupling effects on the pixel.

FIG. 2 shows a state in which a black window is displayed on a screen comprising a set of pixels as shown in FIG. 1. The black window is situated at a center of the screen, and the other background parts are all displayed with a halftone (gray). On the screen, a pixel A is situated on a signal line 1, and pixels B and C are situated on a signal line 2. The signal line 1 does not cross the black window, whereas the signal line 2 passes over the black window. The pixels A, B, and C should have the same brightness; however, a vertical crosstalk causes a slight difference. The pixel B situated above the black window is darker than the original gray, while the pixel C situated below the black window is lighter than the original gray. This is the vertical crosstalk that causes a difference of 5 to 6% in brightness between the pixel B and the pixel C, which difference is easy to perceive visually. It is an object of the present invention to suppress the vertical crosstalk and reduce the brightness difference between the pixel B and the pixel C to 2% or less, which value renders visual perception of the difference impossible.

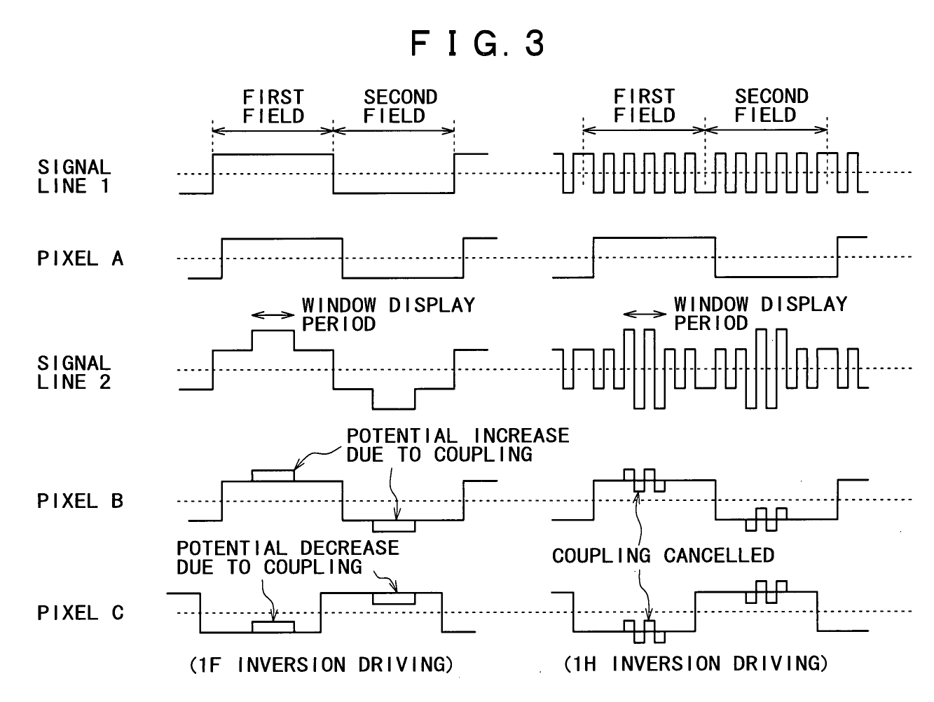

FIG. 3 is a timing chart for comparison between 1F inversion driving and 1H inversion driving, showing changes in potential of signal lines and pixels when the screen of FIG. 2 is displayed. In 1F inversion driving, a video signal applied to the signal line 1 is inverted in each field. In the example of FIG. 3, a video signal of positive polarity is applied in a first field, and a video signal of negative polarity is applied in a second field. A halftone video signal is applied to the signal line 1 at all times during a field period. For example, a video signal potential of ±2 V with respect to a reference potential represented by a dotted line is supplied to the signal line 1. The halftone video signal is written to the pixel A situated on the signal line 1, and the potential of the pixel A is fixed at ±2 V. On the other hand, in the signal line 2, the first field is divided into periods when an intermediate potential is applied to the signal line 2 and when a black potential is applied to the signal line 2. During precisely the period of display of the black window, the potential of the signal line 2 is increased from 2 V to 5 V, for example. Similarly, in the second field of negative polarity, the potential level is decreased from −2 V to −5 V during precisely the period of display of the black window.

Basically ±2 V for the halftone is written to the pixel B situated in the background part above the black window. However, the pixel B is situated on the signal line 2, and is varied in potential by coupling effects. Since the signal line 2 is changed from an absolute value of 2 V to an absolute value of 5 V during the period of display of the black window as described above, this variation Δ3 V is caused to jump into a pixel B side by capacitive coupling, thus varying the potential. Since the coupling increases the absolute potential of the pixel B in the first field and the second field, as shown in FIG. 3, the pixel B is darker than the halftone. On the other hand, the pixel C is situated in the background part below the black window. An intermediate level (−2 V) of negative polarity is written to the pixel C in a previous field. Proceeding from the previous field to the present field, the potential of the signal line 2 is increased by Δ3 V during the period of display of the black window. This potential variation jumps into the pixel C due to coupling. Since unlike the pixel B, the pixel C is maintained in negative polarity in the previous field, the pixel C is decreased in the absolute value of potential when affected by coupling. As a result, the pixel C is lighter than the halftone. The vertical crosstalk is thus caused in 1F inversion driving.

In 1H inversion driving, on the other hand, the video signal is inverted in each horizontal period. Directing attention to the signal line 1, for example, the video signal is inverted in each horizontal period between +2 V and −2 V in both of a first field and a second field. As a result, potential jumping into the pixel B due to coupling is inverted in 1H periods. Therefore the coupling is cancelled, so that no noticeable vertical crosstalk appears. Similarly, noise jumping from the signal line 2 into the pixel C due to coupling is inverted in 1H periods, and is therefore cancelled. Thus, as compared with 1F inversion driving, 1H inversion driving is theoretically less prone to cause a vertical crosstalk.

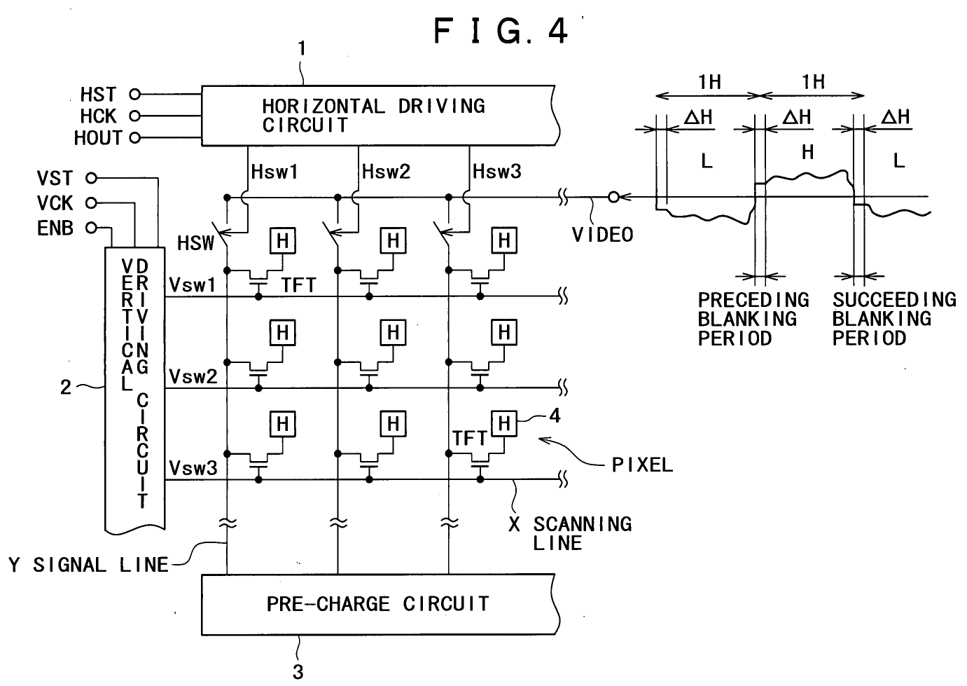

FIG. 4 is a schematic circuit diagram showing an embodiment of a display device according to the present invention. As shown in the figure, the display device has a screen comprising scanning lines X arranged in a form of rows, signal lines Y arranged in a form of columns, and pixels arranged in a form of a matrix in correspondence with intersections of the scanning lines X and the signal lines Y. A pixel comprises a pixel electrode 4 and a TFT for driving the pixel electrode 4. The TFT has a gate electrode connected to a corresponding scanning line X, a source electrode connected to a corresponding signal line Y, and a drain electrode connected to the corresponding pixel electrode 4. A horizontal driving circuit 1, a vertical driving circuit 2, and a pre-charge circuit 3 are disposed around the pixels disposed in the form of a matrix. The horizontal driving circuit 1 samples a video signal VIDEO to the signal lines Y in the form of columns in each horizontal period. In the example of FIG. 4, a video line for supplying the video signal VIDEO and each signal line Y are connected to each other via a switch HSW. The horizontal driving circuit 1 sequentially outputs sampling pulses Hsw1, Hsw2, Hsw3, . . . in one horizontal period, and thereby sequentially opens and closes switches HSW to sample the video signal VIDEO into each signal line Y on a dot-sequential basis. The horizontal driving circuit 1 basically comprises a shift register. The horizontal driving circuit 1 sequentially transfers an externally supplied horizontal start pulse HST in response to an externally supplied clock pulse HCK, and thereby outputs the sampling pulses Hsw1, Hsw2, and Hsw3. Incidentally, an end signal HOUT is outputted when HST transfer is completed in each horizontal period.

The vertical driving circuit 2 sequentially scans the scanning lines X in the form of rows, and thereby selects pixels in each row to write a video signal VIDEO for each horizontal period to pixels in each selected row and retain a video signal for one field. In a next field, a video signal of the same inverted polarity is retained, whereby so-called 1F inversion is performed. The vertical driving circuit 2 in a form shown in FIG. 4 operates in response to a start pulse VST and clock signals VCK and ENB and the like supplied externally, and thereby sequentially outputs selecting pulses Vsw1, Vsw2, Vsw3, . . . to the respective scanning lines X to drive the TFTs of the pixels for opening and closing operation thereof.

As a point of the present invention, the horizontal driving circuit 1 samples the video signal VIDEO inverted in polarity in each horizontal period to the signal lines Y in the form of rows in each horizontal period. Thereby effects of capacitive coupling noise jumping from the signal lines Y into the pixels are cancelled. The video signal VIDEO in the example shown in the figure is in negative polarity (L) in a first H and is inverted to positive polarity (H) in a next H. Thereafter the video signal VIDEO is inverted in polarity in each H in such a manner as L, H, L, H, . . . . This 1H inverted video signal is sampled into each signal line Y as it is, which is the same as in normal 1H inversion driving. As a result, coupling noise jumping from the signal line Y into the pixel is cancelled, so that vertical crosstalk does not occur. In the meantime, the vertical driving circuit 2 sequentially scans the scanning lines X in the form of rows in every other horizontal period, and thereby selects pixels in each row to write video signals of the same polarity in the video signal VIDEO inverted in polarity in each horizontal period to pixels in each selected row and retain the video signals of the same polarity over one field. In the example shown in the figure, 1H thinned-out scanning is performed for the video signal VIDEO inverted in polarity in each H between H and L, whereby a video signal of positive polarity (H) is written to each pixel electrode 4. In a next field, a negative-polarity video signal L is written to each pixel electrode 4, whereby so-called 1F inversion is realized. Thus, in the present invention, 1H inversion driving is used for the signal lines. Thereby coupling can be cancelled. On the other hand, 1H thinned-out driving is used for the pixels, whereby 1F inversion is realized. It is consequently possible to cancel vertical crosstalk by 1F inversion driving. Such 1H thinned-out inversion driving has an advantage of canceling coupling between a pixel and a signal line because the polarity of the video signal is changed in each H on a signal line side, and thereby eliminating vertical crosstalk, which is a problem in normal 1F inversion.

The horizontal driving circuit 1 in the present embodiment forms video signals VIDEO having an identical waveform and opposite polarities from each other into a pair, and samples each video signal comprising such a pair in two horizontal periods to the signal lines Y in the form of columns. In the meantime, the vertical driving circuit 2 sequentially scans the scanning lines X in the form of rows at a rate of one scanning line in every two horizontal periods, and thereby selects pixels in each row to write video signals of the same polarity among video signals of opposite polarities from each other included in pairs to pixels in each selected row. Preferably, the vertical driving circuit 2 comprises a shift register, and generates the pulses Vsw1, Vsw2, Vsw3, . . . for sequentially scanning the scanning lines X in the form of rows in every other horizontal period by subjecting the clock signal VCK having a period four times the horizontal period to gate processing with the clock signal ENB having a period twice the horizontal period.

The horizontal driving circuit 1 in the present embodiment samples a video signal VIDEO separated by blanking periods (ΔH) in each horizontal period (1H) to the signal lines Y in the form of columns in each H. The vertical driving circuit 2 writes the video signal to pixels in a row selected in one horizontal period sandwiched by blanking periods ΔH. At that time, the display device optimizes timing control necessary for writing the video signal in a preceding blanking period positioned before the writing of the video signal and a succeeding blanking period positioned after the writing of the video signal. In the example shown in the figure, a waveform H of positive polarity in video signals inverted in polarity in each H between L and H is written to each pixel. Thus, in timing shown in the figure, the preceding blanking period is positioned before the video waveform H, and the succeeding blanking period is positioned after the video waveform H.

A concrete example of the optimization is first performed by the pre-charge circuit 3. The pre-charge circuit 3 performs pre-charge for preliminarily charging the signal lines Y in the form of columns in each blanking period. At that time, the pre-charge circuit 3 performs pre-charge in the preceding blanking period for a longer time than pre-charge in the succeeding blanking period. The pre-charge circuit 3 in the preceding blanking period performs a first pre-charge for charging the signal lines Y so as to make current leakage between the signal lines Y and the pixels uniform over all of the pixels, and a second pre-charge for charging the signal lines Y to an intermediate potential of the video signal. In the succeeding blanking period, the pre-charge circuit 3 performs only the second pre-charge, and the first pre-charge is omitted.

As another concrete example of the optimization, as compared with timing of a rising edge of a pulse Vsw outputted to a scanning line X to select a row of pixels in the preceding blanking period, the vertical driving circuit 2 shifts rearward timing of a falling edge of the pulse Vsw in the succeeding blanking period, whereby fixation of the video signal written to the pixels is ensured.

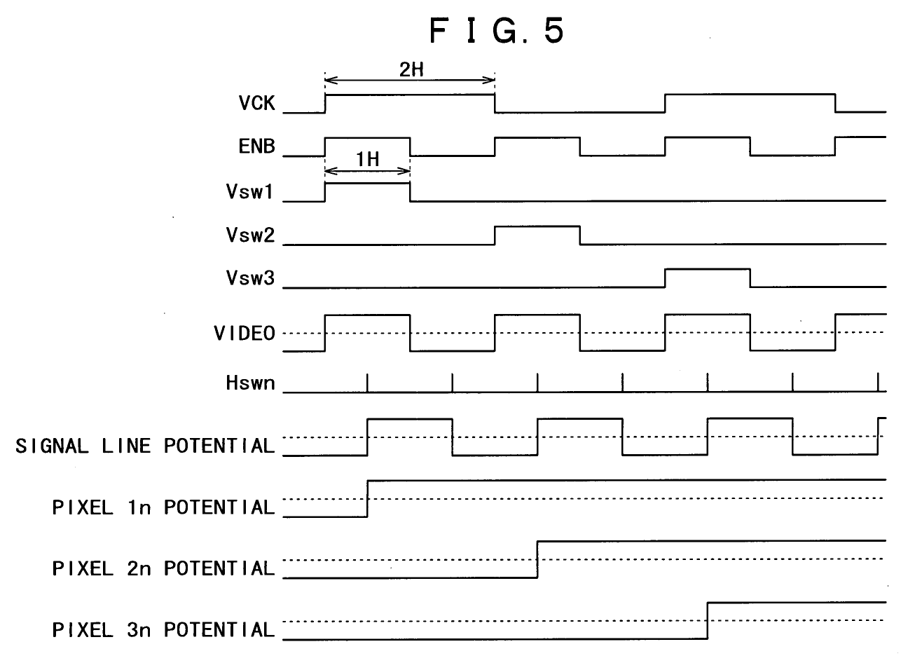

FIG. 5 is a timing chart of assistance in explaining operation of the display device shown in FIG. 4. As described above, the vertical driving circuit comprises a shift register, and outputs a selecting pulse from each stage by sequentially transferring a start pulse in response to a clock signal. In the example shown in FIG. 5, a clock signal VCK is extracted from each stage of the shift register, and is shaped by another clock signal ENB, whereby selecting pulses Vsw1, Vsw2, Vsw3, . . . are outputted. As is clear from the timing chart, the selecting pulse Vsw is outputted in every other H, so that 1H thinned-out driving is realized. A video signal VIDEO is inverted in each H. In such a manner as to correspond thereto, a sampling pulse Hsw is outputted from the horizontal driving circuit in each horizontal period. In order to facilitate understanding, only a sampling pulse Hswn for sampling the video signal VIDEO into the signal line of an nth column is shown in the timing chart of FIG. 5. As shown in FIG. 5, a sampling pulse Hswn is outputted in each horizontal period. In response to the sampling pulse Hswn, the video signal VIDEO inverted in each H is sampled as potential of the signal line of the nth column. Thus, normal 1H inversion driving is performed as far as the signal lines are concerned.

Returning to a vertical driving circuit side, a first pixel row is selected by output of a selecting pulse Vsw1. As a result, at a time of output of a sampling pulse Hswn, a signal potential of positive polarity is written and retained in a pixel 1n positioned at an intersection of the first row and the nth column. A sampling pulse Hswn is outputted in a next H; however, since the selecting pulse Vsw1 has already fallen, a video signal VIDEO of negative polarity is not written to the pixel in, and the previous video signal VIDEO of positive polarity is retained as it is. Similarly, thereafter a video signal VIDEO of positive polarity is written to a pixel 2n positioned at an intersection of a second row and the nth column at a time of application of a selecting pulse Vsw2 and output of a sampling pulse Hswn. Thus, the video signal of positive polarity is written and retained in each pixel during a field period.

As described above, in the display device according to the present invention, the cycle of a VCK pulse is twice a normal cycle (lengthened from 2H to 4H). Then, a normal VCK pulse (a cycle of 2H) is used as the ENB pulse for extracting the Vsw pulse. The other pulses are the same as in normal 1H inversion driving. As a result, the Vsw pulse is outputted from the vertical driving circuit to each scanning line in every other H, and the gates of the TFTs are opened for one H in every two Hs. On the other hand, since the sampling pulse Hsw is outputted in each H and the video signal is inputted with 1H inversion (H, L, H, L, . . . ), the potential of the signal lines is changed in polarity in each H. With such waveform timing, it is possible to use 1F inversion for the pixels and 1H inversion for the signal lines, and thus realize 1F inversion without causing vertical crosstalk.

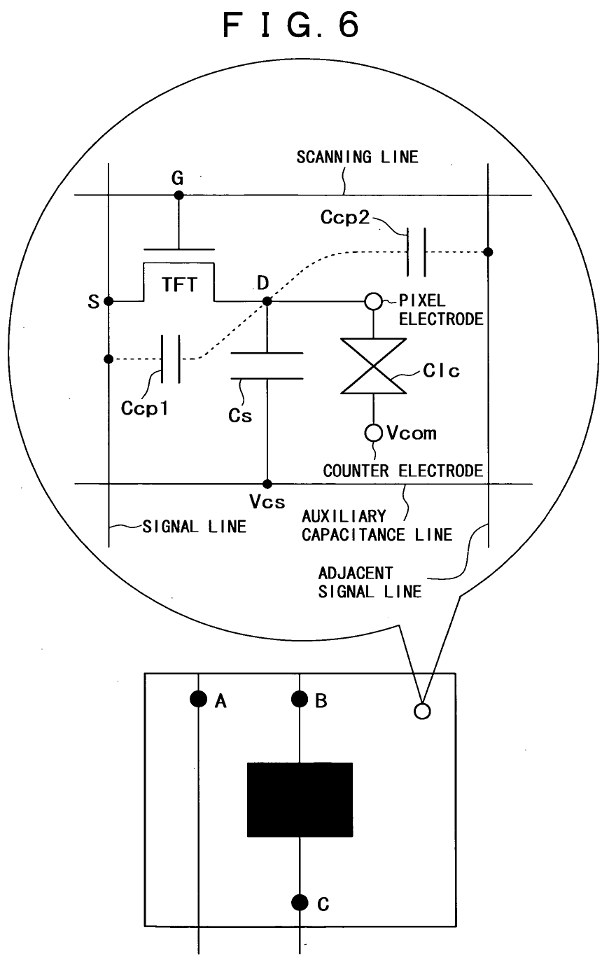

FIG. 6 is a schematic diagram showing an example of a screen of the display device according to the present invention. In order to facilitate understanding, parts corresponding to those in the screen sample of the conventional display device shown in FIG. 2 are identified by corresponding reference numerals. FIG. 6 shows a case where a black window is displayed at a center of the screen against a halftone background on the screen of the active matrix type display device. Unlike conventional 1F inversion driving, 1H thinned-out inversion driving according to the present invention allows pixels A, B, and C in the background portion to exhibit substantially the same brightness regardless of their position, and thus prevents vertical crosstalk. A difference in brightness between the pixel B and the pixel C is reduced to 1% or less.

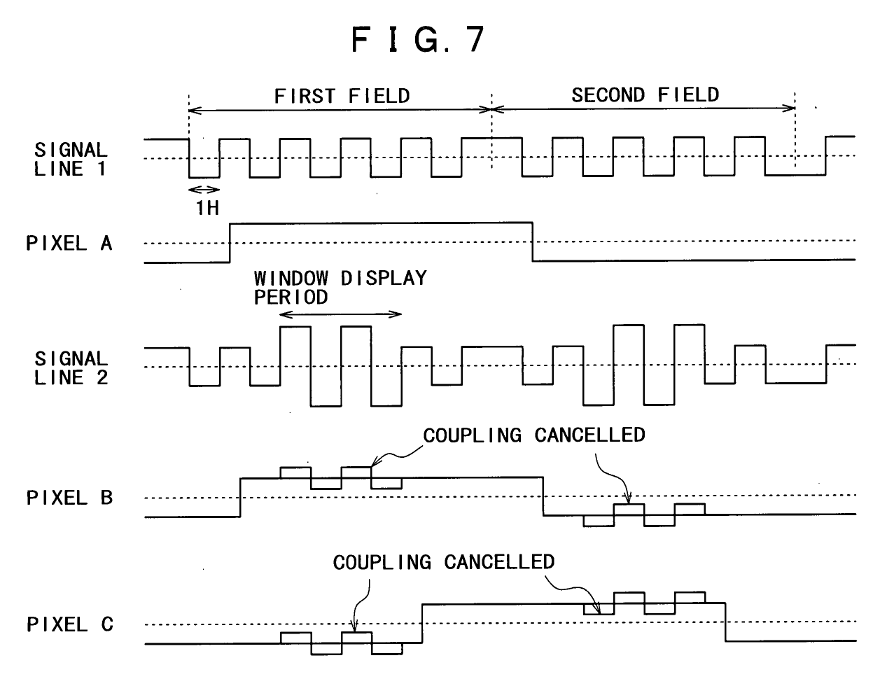

FIG. 7 is a timing chart of the 1H thinned-out inversion driving described with reference to FIG. 6. A potential of a signal line 1 is inverted in polarity between L and H in each H in both a first field and a second field. This is so-called 1H inversion. However, there is a 180° inversion phase shift between the first field and the second field. The pixel A is maintained at an intermediate level during periods of the fields. The pixel A is maintained at +2 V in the first field and at −2 V in the second field. On the other hand, a signal line 2 passing over the black window is varied to a video signal level of ±5 V during only a period of display of the window. While the pixel B is situated in the background portion and is therefore written to display a halftone, the pixel B is affected by coupling from the signal line 2 during only the period of display of the window. However, coupling noise jumping from the signal line 2 into the pixel B is inverted in periods of one H, and is thus cancelled. A vertical crosstalk is thereby eliminated. Similarly, coupling noise jumping from the signal line 2 into the pixel C is cancelled, and thereby a vertical crosstalk is eliminated.

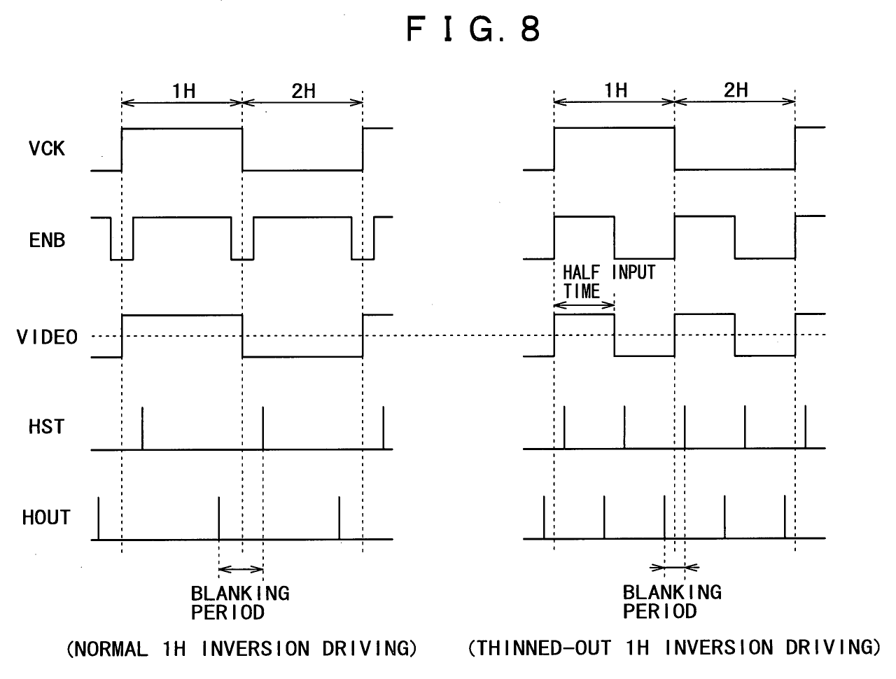

FIG. 8 is a timing chart for a comparison between normal 1H inversion driving and thinned-out 1H inversion driving according to the present invention. In thinned-out 1H inversion driving, horizontal periods are thinned out once in every two horizontal periods. It is to be noted that the present invention is not limited to this; in some cases, thinned-out driving can be performed with a horizontal period omitted once in every three horizontal periods or once in every four horizontal periods. Comparing normal 1H inversion driving and thinned-out 1H inversion driving with each other, clock signals VCK are the same in both cases. A clock signal ENB in normal 1H inversion driving has a waveform having a long duration of an H level because most of each horizontal period is used for writing. On the other hand, a clock signal ENB in thinned-out 1H inversion driving has an H period and an L period equal to each other in one horizontal period, and thus represents a rectangular wave having a duty ratio of 50%. An inversion cycle of a video signal VIDEO in thinned-out 1H inversion driving is halved as compared with that in normal 1H inversion driving. In other words, the video signal VIDEO is doubled in speed in thinned-out 1H inversion driving. This is because only video signals of one polarity are used for writing in thinned-out 1H inversion driving. Also, intervals of occurrence of a horizontal start pulse HST are shortened in thinned-out 1H inversion driving. This is because both waveforms of positive polarity and negative polarity are sampled into the signal lines. When a horizontal start pulse HST is inputted to the horizontal driving circuit and transfer thereof is completed, an end signal HOUT is outputted. A period between the input of the horizontal start pulse HST and the output of the end signal HOUT is a net writing period, and the other period is a blanking period. As is clear from the timing chart of FIG. 8, since thinned-out 1H inversion driving, which is double-speed driving, reduces a 1H period to half a normal 1H period, the blanking period is also shortened as compared with normal 1H inversion driving. The gate of a pixel TFT is opened for only one H in every two Hs in thinned-out 1H inversion driving. A period of the two Hs in this case corresponds to a 1H period in normal 1H inversion driving. That is, because two video signals of different polarities need to be inputted in the normal 1H period, an input time is reduced to half a normal input time. As a result, the blanking period is also reduced to half a normal blanking period.

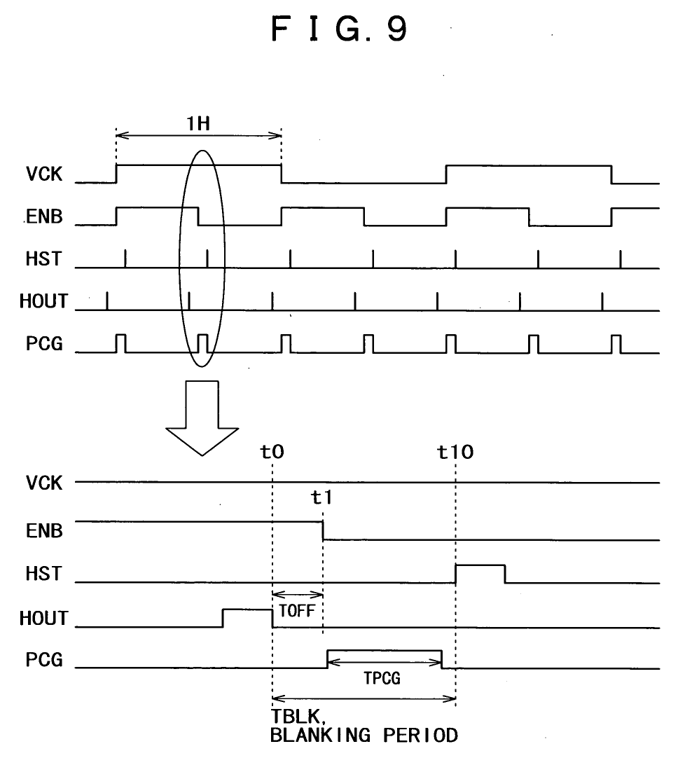

FIG. 9 is a timing chart of various controls performed in a blanking period. The blanking period TBLK is defined between timing t0 when an end signal HOUT is outputted from the horizontal driving circuit and timing t10 when a next start pulse HST is inputted to the horizontal driving circuit. In the blanking period TBLK, a clock signal ENB first falls in timing t1. A gate pulse falls with the falling edge of the clock signal ENB, and therefore pixels are electrically disconnected from the signal lines. At this point in time, a video signal written to the pixels is fixed. As described above, thinned-out 1H inversion double-speed driving shortens the blanking period TBLK. Since a time TOFF required to fix the written video signal is correspondingly shortened, a problem of insufficient writing occurs. Then, after the pixels are disconnected from the signal lines, a pre-charge signal PCG is applied to each signal line. Pre-charging the signal lines is intended to improve picture quality, and is effective in improving uniformity, for example. When double-speed driving is performed, since a time TPCG for this pre-charge is also shortened, pre-charge becomes ineffective, thus causing another crosstalk and a vertical stripe defect.

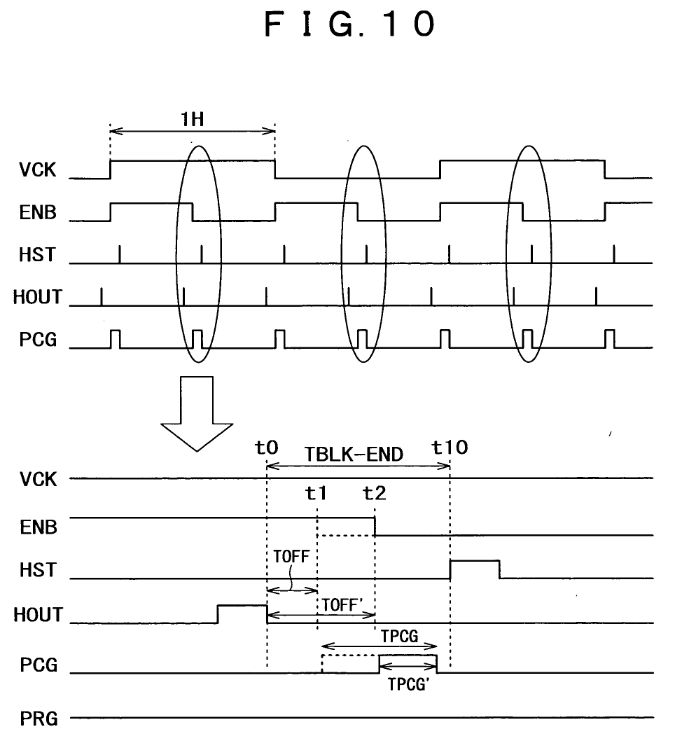

In thinned-out 1H inversion driving, a normal 1H period is divided into two periods, that is, a “period for writing video to the pixels” and a “period for not writing video to the pixels.” There are accordingly a blanking period before writing video to the pixels (preceding blanking period) and a blanking period before not writing video to the pixels, that is, a blanking period after writing the video to the pixels (succeeding blanking period). The present invention solves the above-described problems by optimizing timing control necessary for writing the video signal in the preceding blanking period positioned before the writing of the video signal and the succeeding blanking period positioned after the writing of the video signal. FIG. 10 is a timing chart representing an improving measure applied to the succeeding blanking period TBLK-END. First, timing of a falling edge of the clock signal ENB is shifted from t1 to t2. Thereby the time for fixing the video signal written to the pixels is extended from TOFF to TOFF′. Thus, as compared with timing of a rising edge of a pulse outputted to the scanning line to select the row of pixels in the preceding blanking period, timing of a falling edge of the pulse is shifted rearward in the succeeding blanking period, whereby the fixation of the video signal written to the pixels is ensured. Since the timing of the falling edge of the clock signal ENB is shifted rearward from t1 to t2, the pre-charge time is in turn reduced from TPCG to TPCG′. However, the succeeding blanking period TBLK-END after writing the video signal to the pixels is followed by the thinned-out period, in which no video signal is written to the pixels. Therefore the reduction of the pre-charge period practically has no adverse effects on video quality.

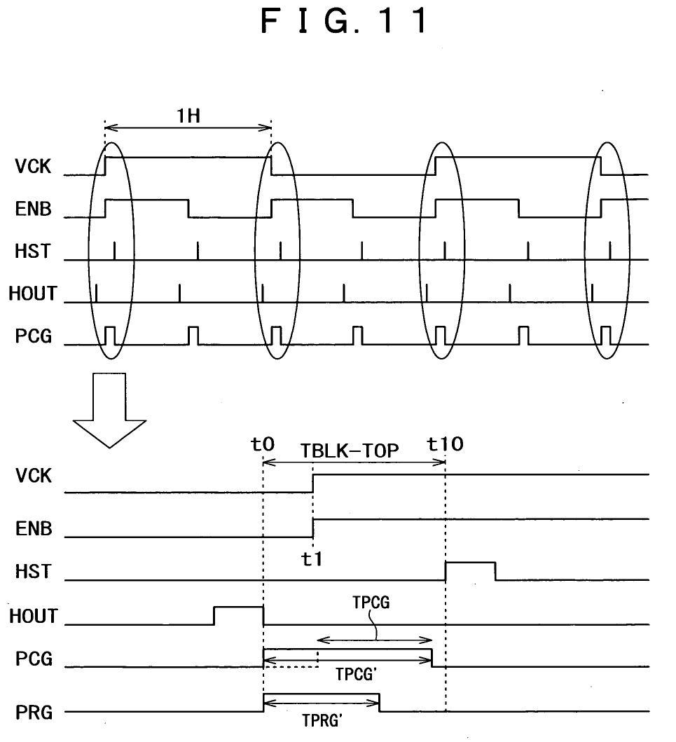

FIG. 11 is a timing chart representing an improving measure applied to the preceding blanking period TBLK-TOP. In the succeeding blanking period TBLK-END, the clock signal ENB falls to disconnect the pixels from the signal lines. In the preceding blanking period TBLK-TOP, on the other hand, the clock signal ENB rises in timing t1 to output a gate selecting pulse from the vertical driving circuit, so that the signal lines and the pixels are electrically connected to each other. When a video signal is written to each pixel, variation in potential of the signal line greatly affects pixel potential. Therefore a time for input of the pre-charge signal as a uniformity improving pulse needs to be long in the preceding blanking period TBLK-TOP. Thinned-out 1H inversion driving does not write video to the pixels in the thinned-out period preceding the preceding blanking period TBLK-TOP. Accordingly, in the preceding blanking period TBLK-TOP, the pre-charge time is extended from TPCG to TPCG′ by starting the input of the pre-charge signal PCG immediately after output of an end signal HOUT. Thus, the present invention sets the time for pre-charge performed in the preceding blanking period TBLK-TOP longer than the time for pre-charge performed in the succeeding blanking period. The present embodiment, in particular, performs a first pre-charge PRG for charging the signal lines so as to make current leakage between the signal lines and the pixels uniform over all of the pixels and a second pre-charge for charging the signal lines to an intermediate potential of a video signal in the preceding blanking period TBLK-TOP. In the timing chart, a first pre-charge time is denoted by TPRG′ and a sum of the first pre-charge time and a second pre-charge time is denoted by TPCG′. Hence, the second pre-charge time is expressed by TPCG′-TPRG′. In the succeeding blanking period TBLK-END, on the other hand, the first pre-charge PRG is omitted and only the second pre-charge is performed, as shown in FIG. 10. In the thinned-out period following the succeeding blanking period TBLK-END, no video signal is written. There is thus little need for the first pre-charge. Thus, thinned-out 1H inversion driving can prevent insufficient writing, crosstalk, a vertical stripe defect and the like by optimizing timing of each pulse waveform in the preceding blanking period and the succeeding blanking period.

By employing thinned-out 1H inversion driving, it is possible to use 1F inversion for pixels and 1H inversion for signal lines and thus realize 1F inversion without causing vertical crosstalk. It is further possible to prevent insufficient writing, vertical crosstalk, a vertical stripe defect and the like by optimizing timing of the waveform of each pulse applied in the preceding blanking period and the succeeding blanking period in thinned-out 1H inversion driving. Thus, the present invention can be applied to display devices with an object of further improving picture quality.

1. A display device comprising:
scanning lines arranged in a form of rows;
signal lines arranged in a form of columns;
pixels arranged in a form of a matrix in correspondence with intersections of the scanning lines and the signal lines;
a horizontal driving circuit for sampling a video signal to the signal lines in each horizontal period; and
a vertical driving circuit for sequentially scanning the scanning lines in the form of rows to select each row of pixels;
wherein a video signal for each horizontal period is written to each selected row of pixels and video signals for one field are retained, and polarity of video signals retained in each field is inverted;
said horizontal driving circuit samples the video signal inverted in polarity in each horizontal period to the signal lines in the form of columns in each horizontal period, whereby an effect of coupling between the signal lines and the pixels is cancelled; and
said vertical driving circuit sequentially scans the scanning lines in every other horizontal period to select each row of pixels, and writes video signals of an identical polarity in the video signal inverted in polarity in each horizontal period to each selected row of pixels and retains the video signals of the identical polarity over one field.

2. A display device as claimed in claim 1, wherein said horizontal driving circuit forms video signals having an identical waveform and opposite polarities from each other into a pair, and samples each of the video signals comprising the pair in two horizontal periods to the signal lines; and
said vertical driving circuit sequentially scans the scanning lines at a rate of one scanning line in every two horizontal periods to select each row of pixels, and writes video signals of an identical polarity among video signals of the opposite polarities from each other included in pairs to each selected row of pixels.

3. A display device as claimed in claim 1,
wherein said vertical driving circuit generates a pulse for sequentially scanning the scanning lines in every other horizontal period by subjecting a clock signal having a period four times one horizontal period to gate processing with a clock signal having a period twice one horizontal period.

4. A display device as claimed in claim 1, wherein said horizontal driving circuit samples a video signal separated by blanking periods in each horizontal period to the signal lines in each horizontal period; said vertical driving circuit writes the video signal to pixels in a row selected in one horizontal period sandwiched by blanking periods; and
timing necessary for writing the video signal in a preceding blanking period positioned before writing of the video signal and a succeeding blanking period positioned after the writing of the video signal is controlled.

5. A display device as claimed in claim 4, further comprising a pre-charge circuit for performing pre-charge for preliminarily charging the signal lines in the form of columns in each blanking period,
wherein said pre-charge circuit performs pre-charge in the preceding blanking period for a longer time than pre-charge in the succeeding blanking period.

6. A display device as claimed in claim 5,
wherein in the preceding blanking period, said pre-charge circuit performs a first pre-charge for charging the signal lines so as to make current leakage between the signal lines and the pixels uniform over all of the pixels, and a second pre-charge for charging the signal lines to an intermediate potential of the video signal; and
in the succeeding blanking period, said pre-charge circuit performs only the second pre-charge, and the first pre-charge is omitted.

7. A display device as claimed in claim 4,
wherein as compared with timing of a rising edge of a pulse outputted to a scanning line to select the row of pixels in the preceding blanking period, said vertical driving circuit shifts rearward timing of a falling edge of the pulse in the succeeding blanking period, whereby fixation of the video signal written to the pixels is ensured.

8. A driving method for driving a display device, said display device including: scanning lines arranged in a form of rows; signal lines arranged in a form of columns; and pixels arranged in a form of a matrix in correspondence with intersections of the scanning lines and the signal lines, said driving method comprising:
a horizontal driving step for sampling a video signal to the signal lines in each horizontal period; and
a vertical driving step for sequentially scanning the scanning lines in the form of rows to select each row of pixels;
wherein a video signal for each horizontal period is written to each selected row of pixels and video signals for one field are retained, and polarity of video signals retained in each field is inverted;
said horizontal driving step samples the video signal inverted in polarity in each horizontal period to the signal lines in each horizontal period, whereby an effect of coupling between the signal lines and the pixels is cancelled; and
said vertical driving step sequentially scans the scanning lines in every other horizontal period to select each row of pixels, and writes video signals of an identical polarity in the video signal inverted in polarity in each horizontal period to each selected row of pixels and retains the video signals of the identical polarity over one field.
